(19) United States
(12) Patent Application Publication
(10) Pub. No.: US 2010/0014008 A1
(43) Pub. Date: Jan. 21, 2010

(54) WIDE COLOR GAUT HIGH RESOLUTION DMD PROJECTION SYSTEM

(76) Inventor: Youngshik Yoon, Valencia, CA (US)

Correspondence Address: Robert D. Shedd, Patent Operations;THOMSON Licensing LLC, P.O. Box 5312, Princeton, NJ, 08543-5312, US

(21) Appl. No.: 12/448,320

(22) PCT Filed: Dec. 19, 2006
(86) PCT No.: PCT/US2006/048406

§ 371 Date: Jun. 17, 2009

(51) Int. Cl. H04N 5/74; G03B 21/28

(52) U.S. Cl. 348/771; 353/33; 348/E05.137

(57) ABSTRACT

A wide gamut high resolution projection system has a light source for generating and emitting light, a prism assembly for separating the light into six primary color light beams, and a plurality of digital micromirror device imagers configured to receive and reflect the primary color light beams.

### FIELD OF THE INVENTION

The invention relates to a digital micromirror device (DMD) projection system. In particular, the invention relates to a wide color gamut high resolution DMD projection system.

### BACKGROUND OF THE INVENTION

With the advent of digital micromirror devices (DMD devices) such as digital light processors (DLPS) there has been a desire to integrate the digital projection technology into cinematic theatres for viewing by the public at large. However, as of yet, DMDs (and DLPs in particular) have not yet progressed in native resolution capability so as to allow an acceptable image for large venues which complies with industry standards for display quality. Particularly, the Society of Motion Picture and Television Engineers (SMPTE) promulgates such standards which are well respected by the various members of the motion picture industry. One such standard applies to the display of a all of a Digital Cinema Distribution Masters (DCDMs) (digital packages which contains all of the sound, picture, and data elements needed for a show) in review rooms and theatres. A requirement of the SMPTE standard is that the pixel count of the projected image must be at least 2048×1080 (2K×1K). The standard further requires that the mesh of pixels (the device structure) must be invisible/imperceptible when viewed from a reference viewing distance. While many DMD/DLP projectors meet the minimum requirement regarding resolution, those same projectors cannot meet the second requirement of the standard since the proper reference viewing distance is small enough to cause visibility of the mesh of pixels. Therefore, current DMD/DLP projectors having 2K×1K resolution are not suitable for most commercial theatres where the viewing distance is small and where to prevent the appearance of the pixel mesh from an appropriate viewing distance, a DMD/DLP projector must have a resolution of about 4K×2K (which is not currently commercially available).

Another problem with current projection systems is that the color gamut achieved by typical single projector systems is not as extensive as intended by the director of the film. A common means for improving color reproduction has been to incorporate a three-color prism assembly with an associated three-chip set of digital micromirror device imagers. A light beam that enters the three-color prism assembly, in reaction to known optical coating methods, is selectively reflected or transmitted depending on the wavelength of the light. Further, known total internal reflection techniques, such as providing a small air gap between prism assembly components, are used to control the reflection of the divided components of the light beam. After having been separated into three color components, each light beam color component is directed to and selectively reflected out of the prism assembly by a digital micromirror device imager. Typically, a first digital micromirror device imager reflects a blue. color component of the light beam, a second digital micromirror device imager reflects a green color component of the light beam, and a third digital micromirror device imager reflects a red color component of the light beam. Each digital micromirror device imager may be individually controlled in a known manner to produce a combined color image which is projected from the prism assembly. However, even use of the three-color prism assembly does not provide an adequately wide color gamut for many image projection applications.

It is therefore desirable to develop an improved DMD/DLP projection system.

### SUMMARY OF THE INVENTION

A wide color gamut high resolution projection system has a light source for generating and emitting light, a prism assembly for separating the light into six primary color light beams, and a plurality of digital micromirror device imagers configured to receive and reflect the primary color light beams.

### BRIEF DESCRIPTION OF THE DRAWINGS

FIG. 1 is a schematic illustration of a high resolution digital micromirror device projection system according to an embodiment of the present invention;

FIG. 2 is a schematic illustration of a high resolution digital micromirror device projection system according to a second embodiment of the present invention; and

FIG. 3 is a schematic illustration of a wide color gamut high resolution digital micromirror device projection system according to a third embodiment of the present invention.

### DETAILED DESCRIPTION OF THE INVENTION

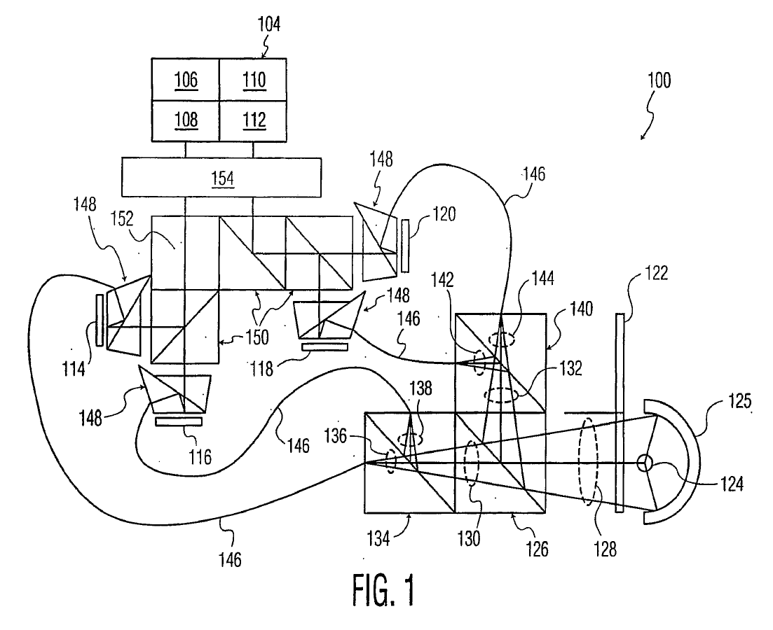

Referring now to FIG. 1 in the drawings, a high resolution DMD projection system according to an embodiment of the present invention is illustrated. While it is currently thought that a single DMD/DLP imager having resolution of about 2048×1080 (2K×1K) is insufficient for accurately reproducing an entire frame of motion picture image data onto a display surface, high resolution DMD projection system 100 advantageously utilizes a plurality of commercially available DMD/DLP imagers (each having resolution of about 2K×1K) to accomplish a total projected image resolution of about 4K×2K, a result acceptable by SMPTE standards. To accomplish this, the entire frame of a target display surface 104 is divided into four regions, an upper left region 106, a lower left region 108, an upper right region 110, and a lower right region 112. Region 106 is to be projected onto by DMD/DLP imager 114, region 108 is to be projected onto by DMD/DLP imager 116, region 110 is to be projected onto by DMD/DLP imager 118, and region 112 is to be projected onto by DMD/DLP imager 120 such that each imager 114, 116, 118, 120 projects only a discrete portion of an entire frame of a motion picture image. In this embodiment, each imager 114, 116, 118, 120 is configured to project a substantially equal area of an entire frame of a motion picture image onto the display surface 104. However, it will be appreciated that in alternative embodiments, the imagers may be configured to project unequal portions of a motion picture image while still providing a high resolution display. Each DMD/DLP imager 114, 116, 118, and 120 is substantially similar to known single-imager type DMD/DLP imagers, but instead of each DMD/DLP imager 114, 116, 118, and 120 having a color wheel filter (as known in the art), a single color wheel filter 122 is used.

In operation, white light or full spectrum light is emitted from a light source 124 and is directed through the spinning color wheel filter 122, with guidance from an elliptical reflector 125. Since each DMD/DLP imager 114, 116, 118, and 120 must be supplied with light, the light exiting the spinning color wheel filter 122 is separated into four separate beams or channels of light (ideally identical in intensity and color) through the use of light beam splitting prisms. A first light beam splitting prism 126 splits the original light beam 128 into two new light beams 130 and 132. Light beam 130 is directed from prism 126 into a second light beam splitting prism 134, resulting in light beams 136 and 138. Light beam 132 is directed from prism 126 into a third light beam splitting prism 140, resulting in light beams 142 and 144. Each of light beams 136, 138, 142, and 144 are directed into and delivered through optical fibers (or equivalent thereof) 146 to total internal reflection lenses (TIR lenses) 148 associated with DMD/DLP imagers 114, 116, 118, and 120, respectively, such that each imager 114, 116, 118, and 120 receives a single beam of light. TIR lenses are known in the art as being suitable for receiving light, directing the received light to a DMD/DLP imager, and finally outputting the light according to an image signal of the DMD/DLP imager. However, it will be appreciated that in an alternative embodiment, the TIR lenses may be replaced by field lenses. TIR lenses 148 are oriented to direct their output into an arrangement of reflective prisms 150 and optical blocks (or compensation optics) 152 so as to forward the four light beams 136, 138, 142, and 144 (or channels of light) (as altered by DMD/DLP imagers 114, 116, 118, and 120) into a projection optics system 154. Projection optics system 154 ultimately directs the light beams 136, 138, 142, and 144 onto regions 106, 108, 110, and 112, respectively, of the entire frame of the target display surface 104. The input signals sent from display controllers of DMD/DLP imagers 114, 116, 118, and 120 to the mirrors of the respective DMD/DLP imagers comprise only the data necessary to create the desired image to be projected onto the associated regions of display surface 104. Further, the received beams of light are manipulated by imagers 114, 116, 118, and 120 to carry motion picture image data corresponding to only a discrete portion of an entire motion picture image frame. It will be appreciated that in other embodiments of the present invention, more or fewer DLP imagers may be incorporated to achieve a higher or lower overall film screen resolution, respectively.

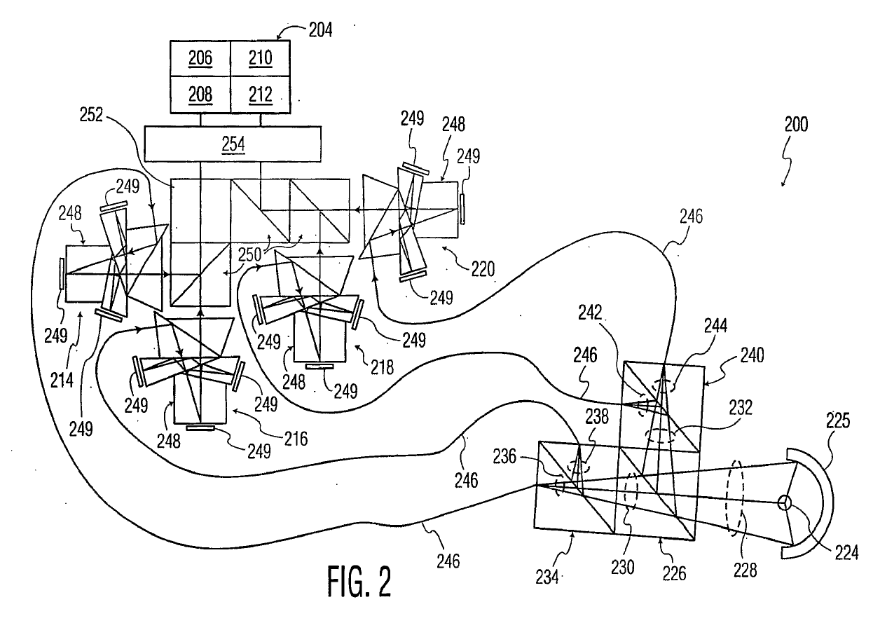

Referring now to FIG. 2 in the drawings, a high resolution DMD projection system according to a second embodiment of the present invention is illustrated. High resolution DMD projection system 200 is similar to system 100 in many ways including the fact that it advantageously utilizes a plurality of commercially available DMD/DLP imagers (each having resolution of about 2K×1K) to accomplish a total projected image resolution of about 4K×2K, a result acceptable by SMPTE standards. To accomplish this, the entire frame of a target display surface 204 is divided into four regions, an upper left region 206, a lower left region 208, an upper right region 210, and a lower right region 212. However, system 200 comprises four three-imager sets 214, 216, 218, and 220 each comprising three DMD/DLP imagers 249 (the three-imager type DMD/DLP imagers being known in the art) instead of four single-imager type imagers (like 114, 116, 118, and 120). Region 206 is to be projected onto by DMD/DLP imager set 214, region 208 is to be projected onto by DMD/DLP imager set 216, region 210 is to be projected onto by DMD/DLP imager set 218, and region 212 is to be projected onto by DMD/DLP imager set 220. Since each DMD/DLP imager of the three-DMD/DLP imager sets 214, 216, 218, 220 consistently manipulates a single color (red, green, or blue) there is no need for a color wheel filter (as needed in system 100).

In operation, white light or fill spectrum light is emitted from a light source 224 with guidance from an elliptical reflector 225. Since each DMD/DLP imager set 214, 216, 218, and 220 must be. supplied with light, the light exiting the light source 224 is separated into four channels of light (ideally identical in intensity and color) through the use of light beam splitting prisms as was similarly provided for in system 100. A first light beam splitting prism 226 splits the original light beam 228 into two new light beams 230 and 232. Light beam 230 is directed from prism 226 into a second light beam splitting prism 234, resulting in light beams 236 and 238. Light beam 232 is directed from prism 226 into a third light beam splitting prism 240, resulting in light beams 242 and 244. Each of light beams 236, 238, 242, and 244 are directed into and delivered through optical fibers (or equivalent thereof) 246 to TIR lens/dichroic prism assemblies 248 associated with DMD/DLP imager sets 214, 216, 218, and 220, respectively. Assemblies 248 are known for splitting a light beam into three primary color light beams (red, green, and blue). TIR lens/dichroic prism assemblies 248 are known for receiving light, directing the received light to DMD/DLP imagers 249, and finally outputting the light. However, it will be appreciated that in an alternative embodiment, the TIR lens portion of the TIR lens/dichroic prism assemblies may be replaced by field lenses. Assemblies 248 are oriented to direct their output into an arrangement of reflective prisms 250 and optical blocks (or compensation optics) 252 so as to forward the. four light beams 236, 238,242, and 244 (or channels of light) (as altered by DMD/DLP imager sets 214, 216, 218, and 220) into a projection optics system 254. Projection optics system 254 ultimately directs the light beams 236, 238, 242, and 244 onto regions 206, 208, 210, and 212, respectively, of the entire frame of the target display surface 204. The input signals sent from display controllers of DMD/DLP imager sets 214, 216, 218, and 220 to the mirrors of the respective DMD/DLP imagers comprise only the data necessary to create the desired image to be projected onto the associated regions of display surface 204. It will be appreciated that in other embodiments of the present invention, more or fewer DLP imagers may be incorporated to achieve a higher or lower overall projected image resolution, respectively. By incorporating DMD/DLP imager sets 214, 216, 218, and 220, so-called rainbow effects (caused in part by the existence of a color wheel such as color wheel 122) are avoided and a higher level of color control is achieved.

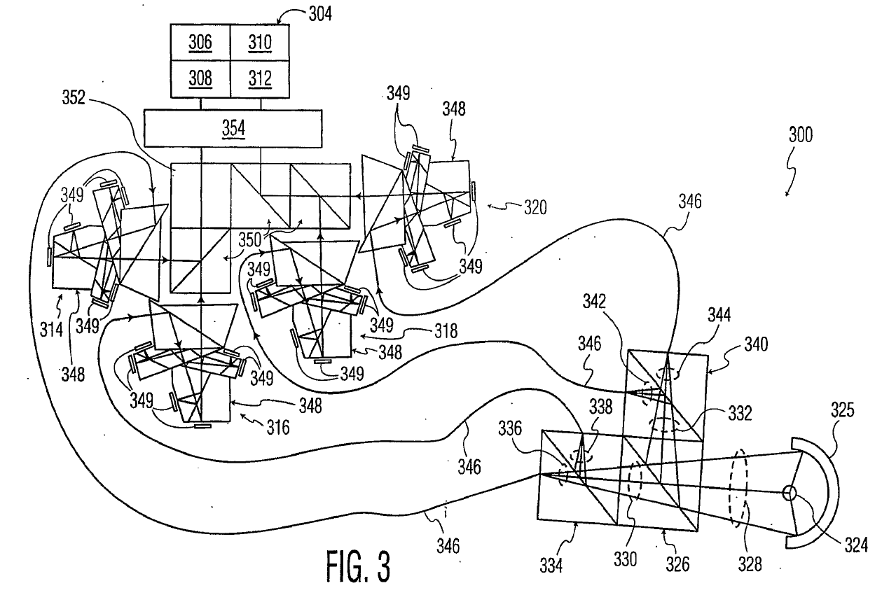

Referring now to FIG. 3 in the drawings, a high resolution DMD projection system according to a third embodiment of the present invention is illustrated. High resolution DMD projection system 300 is substantially similar to system 200 in many ways including the fact that it advantageously utilizes a plurality of commercially available DMD/DLP imagers (each having resolution of about 2K×1K) to accomplish a total projected image resolution of about 4K×2K, a result acceptable by SMPTE standards. To accomplish this, the entire frame of a target display surface 304 is divided into four regions, an upper left region 306, a lower left region 308, an upper right region 310, and a lower right region 312. However, system 300 comprises four six-imager-sets 314, 316, 318, and 320 each comprising six DMD/DLP imagers 349. Region 306 is to be projected onto by DMD/DLP imager set 314, region 308 is to be projected onto by DMD/DLP imager set 316, region 310 is to be projected onto by DMD/DLP imager set 318, and region 312 is to be projected onto by DMD/DLP imager set 320. TIR lens/dichroic prism assemblies 348 divide a light beam into six primary color components rather than only three. This is accomplished by introducing 45 degreed dichroics into each primary to create six primary color light beam components for delivery to six digital micromirror device imagers 349, providing a wider color gamut and greater color control at a given refresh or frame rate. In this arrangement, cyan, blue, yellow, green, red, and magenta color components are directed toward and subsequently reflected from digital micromirror device imagers 349. Since each DMD/DLP imager of the six-imager sets 314, 316, 318, 320 consistently manipulates a single color (cyan, blue, yellow, green, red, or magenta) there is no need for a color wheel filter (as needed in system 100).

In operation, white light or full spectrum light is emitted from a light source 324 with guidance from an elliptical reflector 325. Since each DMD/DLP imager set 314, 316, 318, and 320 must be supplied with light, the light exiting the light source 324 is separated into four beams or channels of light (ideally identical in intensity and color) through the use of light beam splitting prisms as was similarly provided for in system 100. A first light beam splitting prism 326 splits the original light beam 328 into two new light beams 330 and 332. Light beam 330 is directed from prism 326 into a second light beam splitting prism 334, resulting in light beams 336 and 338. Light beam 332 is directed from prism 326 into a third light beam splitting prism 340, resulting in light beams 342 and 344. Each of light beams 336, 338, 342, and 344 are directed into and delivered through optical fibers (or equivalent thereof) 346 to TIR lens/dichroic prism assemblies 348 associated with DMD/DLP imager sets 314, 316, 318, and 320, respectively. TIR lens/ dichroic prism assemblies 348 receive light, direct the received light to DMD/DLP imagers 349, and finally output the light. However, it will be appreciated that in an alternative embodiment, the TIR lens portion of the TIR lens / dichroic prism assemblies may be replaced by field lenses. Assemblies 348 are oriented to direct their output into an arrangement of reflective prisms 350 and optical blocks (or compensation optics) 352 so as to forward the four light beams 336, 338, 342, and 344 (or channels of light) (as altered by DMD/DLP imager sets 314, 316, 318, and 320) into a projection optics system 354. Projection optics system 354 ultimately directs the light beams 336, 338, 342, and 344 onto regions 306, 308, 310, and 312, respectively, of the entire frame of the target display surface 304. The input signals sent from display controllers of DMD/DLP imager sets 314, 316, 318, and 320 to the mirrors of the respective DMD/DLP imagers comprise only the data necessary to create the desired image to be printed in the associated regions of display surface 304. It will be appreciated that in other embodiments of the present invention, more or fewer DLP imagers may be incorporated to achieve a higher or lower overall projected image resolution, respectively. By incorporating six-imager DMD/DLP imager sets 314, 316, 318, and 320, so-called rainbow effects (caused in part by the existence of a color wheel such as color wheel 122) are avoided and a higher level of color control is achieved. Further, the DMD/DLP imager sets 314, 316, 318, and 320 offer a much wider color gamut than the three-imager DMD/DLP imager sets 214, 216, 218, and 220.

The foregoing illustrates only some of the possibilities for practicing the invention. Many other embodiments are possible within the scope and spirit of the invention. For example, although a specific embodiment describes the system with six primary colors, systems with four or greater primary colors are also considered embodiments of the invention, with the functional equivalent number of DMD/DLP imagers per set (i.e., the number of imagers per set will equal the number of primary colors). It is, therefore, intended that the foregoing description be regarded as illustrative rather than limiting, and that the scope of the invention is given by the appended claims together with their full range of equivalents.

1. A projection system, comprising:
a light source for generating and emitting light;
a prism assembly for separating the light into six primary color light beams;
a plurality of digital micromirror device imagers configured to receive and reflect the primary color light beams.

2. The projection system according to claim 1, wherein the six primary color light beams are directed to a set of six digital micromirror device imagers and wherein each of the digital micromirror device imagers of the set of six digital mirror device imagers is configured to receive a single primary color light beam of the six primary color light beams.

3. The projection system according to claim 2, wherein the set of six digital micromirror device imagers is configured to project only a discrete portion of an entire frame of a motion. picture image onto a display surface.

4. The projection system according to claim 2, further comprising:
a plurality of sets of six digital micromirror device imagers;
wherein each set of six digital micromirror device imagers is configured to display an equal area of an entire frame of a motion picture image onto a display surface.

5. The projection system according to claim 1, wherein each digital micromirror device imager has a resolution of about 2K×1K.

6. The projection system according to claim 1, further comprising:
a total internal reflection lens optically disposed between the light source and at least one of the digital micromirror device imagers.

7. The projection system according to claim 6, further comprising:
a projection optics system optically disposed between the at least one total internal reflection lens and a display surface.

8. The projection system according to claim 1, further comprising:
a plurality of light beam splitting prisms for splitting the light emitted from the light source into a plurality of separate beams of light.

9. The projection system according to claim 8, wherein each of the separate beams of light is directed to a different set of six digital micromirror device imagers.

10. The projection system according to claim 8, wherein each of a plurality of sets of six digital micromirror device imagers is adapted to receive a single beam of light of the plurality of separate beams of light.

11. The projection system according to claim 8, wherein each of a plurality of sets of six digital micromirror device imagers manipulates a received beam of light to carry motion picture image data corresponding to only a discrete portion of an entire motion picture image frame.

12. The projection system according to claim 1, further comprising:
a projection optics system optically disposed between the plurality of digital micromirror device imagers and a display surface.

13. The projection system according to claim 12, further comprising:
an arrangement of reflective prisms and optical blocks optically disposed between the plurality of digital micromirror device imagers and the projection optics system.

14. The projection system according to claim 1, wherein the primary color light beams are cyan, blue, yellow, green, red, and magenta.

15. The projection system according to claim 1, wherein at least one prism of the prism assembly is a 45 degreed dichroic.

16. A projection system, comprising:
a light source for generating and emitting light;
a prism assembly for separating the light into four or greater primary color light beams;
a plurality of digital micromirror device imagers configured to receive and reflect the primary color light beams.

17. The projection system according to claim 16, further comprising:
a plurality of light beam splitting prisms for splitting the light emitted from the light source into a plurality of separate beams of light.

18. The projection system according to claim 16, wherein each of the separate beams of light is directed to a different set of digital micromirror device imagers, each different set having the same number of digital micromirror device imagers as there are primary color light beams.

19. The projection system according to claim 16, wherein each of a plurality of sets of digital micromirror device imagers is adapted to receive a single beam of light of the plurality of separate beams of light, each of the plurality of sets having the same number of digital micromirror device imagers as there are primary color light beams.

20. The projection system according to claim 16, wherein each of a plurality of sets of digital micromirror device imagers manipulates a received beam of light to carry motion picture image data corresponding to only a discrete portion of an entire motion picture image frame, each of the plurality of sets having the same number of digital micromirror device imagers as there are primary color light beams.
